(19) United States
(12) Patent Application Publication
(10) Pub. No.: US 2006/0100872 A1
(43) Pub. Date: May 11, 2006

(54) PATTERN RECOGNITION APPARATUS AND PATTERN RECOGNITION METHOD

(75) Inventor: Kentaro Yokoi, Kanagawa-ken (JP)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: Kabushiki Kaisha Toshiba, Minato-ku (JP)

(21) Appl. No.: 11/269,430

(22) Filed: Nov. 8, 2005

(30) Foreign Application Priority Data
Nov. 8, 2004 (JP) 2004-323115
Oct. 24, 2005 (JP) 2005-308933

(51) Int. Cl. G10L 15/14

(52) U.S. Cl. 704/256

(57) ABSTRACT

A feature amount extracting unit extracts feature amount vectors of an inputted image. A probability distribution calculator calculates a probability distribution of feature amount vectors in a calculation space range which is set by a calculation space range setting unit. A probability distribution storage stores the probability distribution in association with identifiers of learning objects. A posterior probability calculator calculates a posterior probability, which is a probability that a recognition object corresponds to each of the learning objects, using feature amount vectors calculated from an image of the recognition object and the probability distribution of the learning objects stored in the probability distribution storage. A posterior probability comparing unit compares posterior probabilities calculated and outputs a result of recognition of the recognition object.

### CROSS REFERENCES TO RELATED APPLICATIONS

This application is based upon and claims the benefit of the prior Japanese Patent Applications:

No.P2004-323115 filed on Nov. 8, 2004; and

No.P2005-308933 filed on Oct. 24, 2005; the entire contents of which are incorporated herein by reference.

### TECHNICAL FIELD

The present invention relates to a pattern recognition technique for detecting abnormality and detecting and identifying an object on the basis of pattern information such as an image.

### DESCRIPTION OF RELATED ART

Conventionally, there has been proposed a method of recognizing and identifying an object according to a parametric method (e.g., M. Seki, et al., “A robust background subtraction method for changing background”, MIRU-2000, Vol. 2, pp. 403-408, July 2000). In the method, it is assumed that a distribution of a pattern follows a known model such as the Gaussian distribution. The subspace method is an example of this method.

There has also been proposed a nonparametric method that does not assume a model (e.g., Japanese Patents Nos. 3486229 and 3490196). In this method, it is determined whether an image is a background on the basis of a posterior probability of a luminance of each pixel.

In the parametric method, since an assumed pattern distribution is used, it is necessary that there is no positional deviation among images. Therefore, positioning and deformation of a pattern are performed on the basis of positions and shapes of a plurality of feature points common to the images.

However, the positioning may be difficult. For example, clear definition of the feature points may be difficult or matching of the feature points may be difficult. When positional deviation itself is a feature amount, feature information is lost because of the positioning. Conversely, when the positioning is not performed, since a distribution of the pattern does not always match a model, recognition performance decreases.

In the nonparametric method, it is determined whether a pixel is a background on the basis of a posterior probability of a luminance of the pixel. This is based on the premise that there is no positional deviation among images. Therefore, it is difficult to cope with a case in which there is positional deviation. Since the determination is made based only on extremely local information of the pixel, recognition of a pattern may be unreliable.

### SUMMARY

The following presents a simplified summary in order to provide a basic understanding of one or more aspects of the invention. This summary is not an extensive overview of the invention. It is not intended to identify key or critical elements, nor to delineate the scope of the claimed subject matter. Rather, the sole purpose of this summary is to present some concepts of the invention in a simplified form as a prelude to the more detailed description that is presented hereinafter.

Generally speaking, a pattern recognition method is provided that is a nonparametric method with minimal or no positional deviation considerations or influences.

According to a first aspect of the invention, there is provided a pattern recognition apparatus including: an image input unit that inputs a plurality of images concerning each of a learning object and a recognition object; a feature amount vector calculating unit that calculates a feature amount vector of each of the images; a range setting unit that sets a calculation range in a feature amount vector space for calculating a probability distribution of the feature amount vectors concerning the learning object; a probability distribution calculating unit that calculates, concerning the learning object, the probability distribution of the feature amount vectors in the calculation range; a probability distribution storing unit that stores the probability distribution in association with the learning object; a posterior probability calculating unit that calculates a posterior probability that the recognition object is the learning object using feature amount vectors concerning the recognition object and the probability distribution; and a recognizing unit that recognizes the recognition object on the basis of the posterior probability.

According to a second aspect of the invention, there is provided a pattern recognition method including: inputting a plurality of images concerning each of a learning object and a recognition object; calculating a feature amount vector of each of the images; setting a calculation range in a feature amount vector space for calculating a probability distribution of the feature amount vectors concerning the learning object; calculating, concerning the learning object, the probability distribution of the feature amount vectors in the calculation range; storing the probability distribution in association with the learning object; calculating a posterior probability that the recognition object is the learning object using feature amount vectors concerning the recognition object and the probability distribution; and recognizing the recognition object on the basis of the posterior probability.

According to a third aspect of the invention, there is provided an apparatus for generating a pattern recognition dictionary, the apparatus including: an image input unit that inputs a plurality of images concerning a learning object; a feature amount vector calculating unit that calculates a feature amount vector of each of the images; a range setting unit that sets a calculation range in a feature amount vector space for calculating a probability distribution of the feature amount vectors concerning the learning object; a probability distribution calculating unit that calculates, concerning the learning object, the probability distribution of the feature amount vectors in the calculation range; and an output unit that outputs data in which the probability distribution is associated with the learning object.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following description when considered in conjunction with the drawings.

### BRIEF DESCRIPTION OF THE DRAWINGS

In the accompanying drawings:

FIG. 1 is a block diagram of a pattern recognition apparatus in a first embodiment of the invention;

FIG. 2 is a flowchart of learning processing by the pattern recognition apparatus in the first embodiment;

FIG. 3 is a flowchart of recognition processing by the pattern recognition apparatus in the first embodiment;

FIG. 4 is a diagram of an example of a calculation of a probability distribution;

FIG. 5 is a diagram of an example of a calculation range of a probability distribution;

FIGS. 6A to 6D are graphs of comparison of the first embodiment and reference examples;

FIG. 7 is a block diagram of a modification of the first embodiment;

FIG. 8 is a block diagram of a pattern recognition apparatus in a second embodiment of the invention:

FIG. 9 is a flowchart of recognition processing by the pattern recognition apparatus in the second embodiment;

FIG. 10 is a diagram of an example of a provisional probability;

FIG. 11 is a block diagram of a pattern recognition apparatus in a third embodiment of the invention; and

FIG. 12 is a flowchart of recognition processing by the pattern recognition apparatus in the third embodiment.

### DESCRIPTION OF THE EMBODIMENTS

### First Embodiment

A first embodiment of the invention will be hereinafter explained with reference to the accompanying drawings.

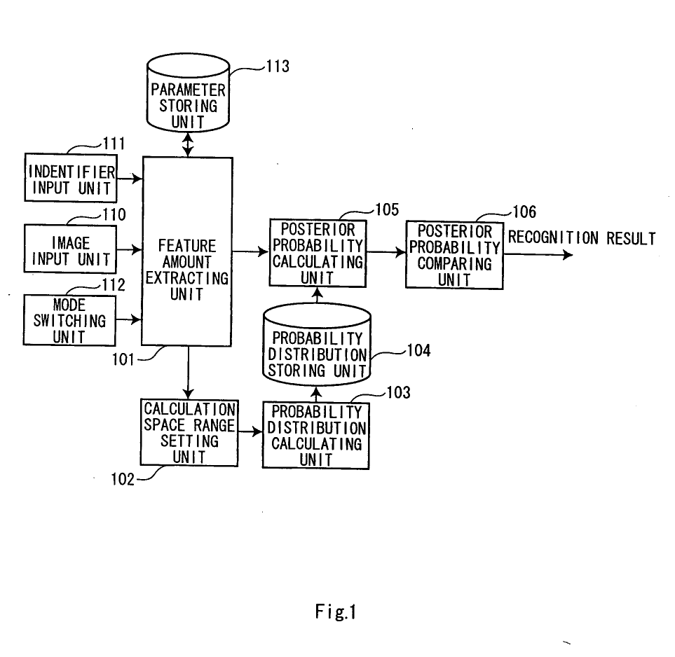

FIG. 1 is a block diagram of a pattern recognition apparatus in the first embodiment. The pattern recognition apparatus includes an image input unit 110 that inputs an image, an identifier input unit 111 that inputs identifiers of learning objects, a feature amount extracting unit 101 that extracts feature amount vectors of the image inputted and feature values the feature amount vectors, and a parameter storing unit 113 that stores data (information on the inputted image) used by the feature amount extracting unit 101 and data (parameters defining a feature amount vector space) generated by the feature amount extracting unit 101.

The pattern recognition apparatus also includes a calculation space range setting unit 102 that sets a range (a calculation space range), in which a probability distribution of the feature amount vectors is calculated in the feature amount vector space, on the basis of the feature amount vectors and the feature values calculated, a probability distribution calculating unit 103 that calculates the probability distribution of the feature amount vectors in the calculation space range, and a probability distribution storing unit 104 that stores the probability distribution calculated in association with the identifiers of the learning objects.

The pattern recognition apparatus also includes a posterior probability calculating unit 105 that calculates a posterior probability, which is a probability that a recognition object corresponds to each of the learning objects, using feature amount vectors calculated from an image of the recognition object and the probability distribution of the learning objects stored in the probability distribution storing unit 104 and a posterior probability comparing unit 106 that compares the posterior probabilities calculated and outputs a result of recognition of the recognition objects.

The pattern recognition apparatus has two kinds of processing modes. One of the processing modes is a learning processing mode and the other is a recognition processing mode. A mode switching unit 112 sends a control signal corresponding to each of the modes to the feature amount extracting unit 101 and the posterior probability calculating unit 105 to thereby switch an operation mode.

In the case of the learning processing mode, the mode switching unit 112 sends a control signal for the learning processing mode. When the feature amount extracting unit 101 receives the control signal, the feature amount extracting unit 101 outputs the extracted feature amount vectors and the like to the calculation space range setting unit 102. When the posterior probability calculating unit 105 receives the control signal, the posterior probability calculating unit 105 stops processing for calculating posterior probabilities.

In the case of the recognition processing mode, the mode switching unit 112 sends a control signal for the recognition processing mode. When the feature amount extracting unit 101 receives the control signal, the feature amount extracting unit 101 outputs the extracted feature amount vectors and the like to the posterior probability calculating unit 105. When the posterior probability calculating unit 105 receives the control signal, the posterior probability calculating unit 105 starts the processing for calculating posterior probabilities.

Operations in the respective processing modes will be schematically explained. In the learning processing mode, the feature amount extracting unit 101 calculates feature amount vectors of images of learning objects. The probability distribution calculating unit 103 calculates a probability distribution of feature amount vectors of the learning objects. The probability distribution storing unit 104 stores a probability distribution of the learning objects as a dictionary.

In the recognition processing mode, the feature amount extracting unit 101 calculates feature amount vectors of an image of a recognition object. The posterior probability calculating unit 105 calculates a posterior probability, which is a probability that the recognition object corresponds to each of the learning objects, using feature amount vectors of the recognition object and the probability distribution stored in the probability distribution storing unit 104. The posterior probability comparing unit 106 recognizes the recognition object on the basis of posterior probabilities.

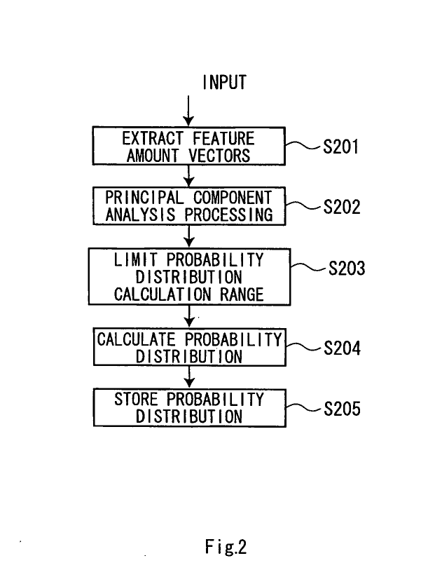

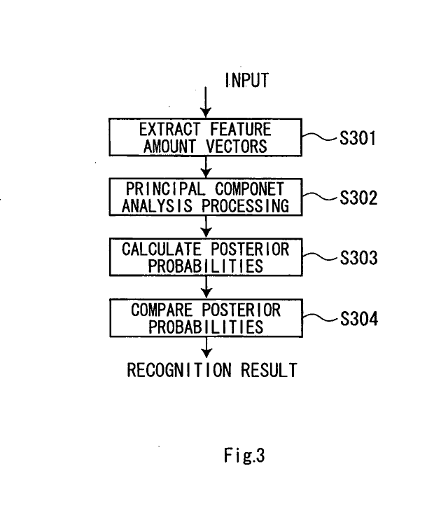

FIG. 2 is a flowchart of learning processing. FIG. 3 is a flowchart of recognition processing. The pattern recognition apparatus in this embodiment performs the learning processing and the recognition processing using an m×n-dimensional image pattern having m pixels vertically and n pixels horizontally.

The learning processing will be explained with reference to FIG. 2.

(Act S201) Feature Amount Extraction Processing

The feature amount extracting unit 101 extracts source feature amount vectors x from an inputted image of a learning object. A source feature amount vector is a vector, each component of which has an amount on which information in an image is reflected. The amount on which information in an image is reflected is, for example, edge information in the image, angle information of an edge in the image, or a luminance value itself of each pixel.

The pattern recognition apparatus in this embodiment uses the luminance value itself of each pixel. Therefore, the feature amount extracting unit 101 extracts m×n-dimensional source feature amount vectors x from the image of the learning object.

Each of the source feature amount vectors x corresponds to an input pattern in this embodiment.

(Act S202) Principal Component Analysis Processing

The feature amount extracting unit 101 applies principal component analysis to all the source feature amount vectors x and calculates L-dimensional feature amount vectors y corresponding to each of the source feature amount vectors x and L eigenvalues λ (L≦m×n).

Each of the L-dimensional feature amount vectors y corresponds to a processing pattern used by the pattern recognition apparatus in this embodiment. In other words, in act S202, the feature amount extracting unit 101 applies the principal component analysis to an m×n-dimensional input pattern and generates an L-dimensional processing pattern.

The feature amount extracting unit 101 applies the principal component analysis to a plurality of source feature amount vectors x and calculates an average source feature amount vector xₐᵥₑ, eigenvalues λᵢ (i=1, 2, . . . ,L) and eigenvectors φᵢ (i=1, . . . ,L). Each of the eigenvalues λᵢ corresponds to each of the eigenvectors φᵢ (i=1, 2, . . . ,L). The eigenvalues λᵢ are, for example, L of the largest eigenvalues. Each of the eigenvector φᵢ is m×n-dimensional vector. The feature amount extracting unit 101 calculates the L-dimensional feature amount vectors y according to a relational expression y=[φ₁, φ₂, . . . , φ_{L}] (x-xₐᵥₑ). In this expression, the [φ₁, φ₂, . . . , φ_{L}] is a matrix having the eigenvectors φᵢ as components and this matrix projects the vector (x-xₐᵥₑ) onto a space characterized by the eigenvectors φᵢ. Moreover, the feature amount extracting unit 101 calculates an average feature amount vector yₐᵥₑ according to a relational expression yₐᵥₑ=[φ₁, φ₂, . . . , φ_{L}]Xₐᵥₑ.

The feature amount extracting unit 101 outputs the average feature amount vector yₐᵥₑ, L eigenvalues λᵢ (i=1, 2, . . . L), identifiers cⱼ (j=1, 2, . . . , C) of learning objects inputted by the identifier input unit 111, and the L-dimensional feature amount vectors y to the calculation space range setting unit 102. In this case, each of the plurality of L-dimensional feature amount vectors y is outputted in association with the identifiers cⱼ of the learning objects. Note that, in the following explanation, a “set concerning the learning objects identified by the identifiers cⱼ” is described as a “class cⱼ”.

The feature amount extracting unit 101 outputs the source feature amount vectors x, the identifiers cⱼ, the L eigenvalues λᵢ, the eigenvectors φᵢ (i=1, 2, . . . ,L), and the average source feature amount vector xₐᵥₑ to the parameter storing unit 113. The parameter storing unit 113 stores the source feature amount vectors x in association with the identifiers cⱼ. The parameter storing unit 113 stores each eigenvalue and eigenvectors corresponding thereto in association with each other.

(Act S203) Limitation of a Calculation Space Range

The calculation space range setting unit 102 sets a range (a calculation space range), in which a probability distribution of the feature amount vectors y is calculated in an L-dimensional feature amount vector space Y, using the L eigenvalues λᵢ (i=1, 2, . . . , L).

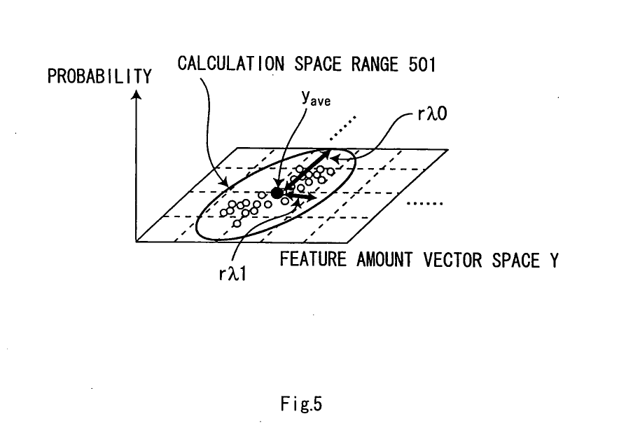

Specifically, as shown in FIG. 5, the range is limited to a range 501 of a radius rλᵢ (i=1, 2, . . . , L) with the average feature amount vector yₐᵥₑ as a center. In other words, for an ith dimension of the feature amount vector space Y, the range is limited to a range 501 of a radius rλᵢ with yₐᵥₑⁱ, which is an ith dimension component of the average feature amount vector yₐᵥₑ, as a center. A probability distribution of each of the learning objects is calculated in the calculation space range.

The feature amount vector space Y has an infinite expanse. It is necessary to limit a calculation range in order to calculate a probability distribution numerically in finite time. In the case of a calculation method in this embodiment, if it is possible to limit a range of a probability distribution according to the Gaussian distribution, 99.74% of the entire distribution is included when r=3 and 99.9% of the entire distribution is included when r=4. Thus, it is possible to calculate a probability distribution with sufficient accuracy even if a space is limited.

(Act S204) Calculation of a Probability Distribution

The probability distribution calculating unit 103 calculates probability distributions of the feature amount vectors y in the L-dimensional feature amount vector space Y within the calculation space range set in act S203. A probability distribution is calculated for each learning object. In other words, one probability distribution is calculated for one class cⱼ.

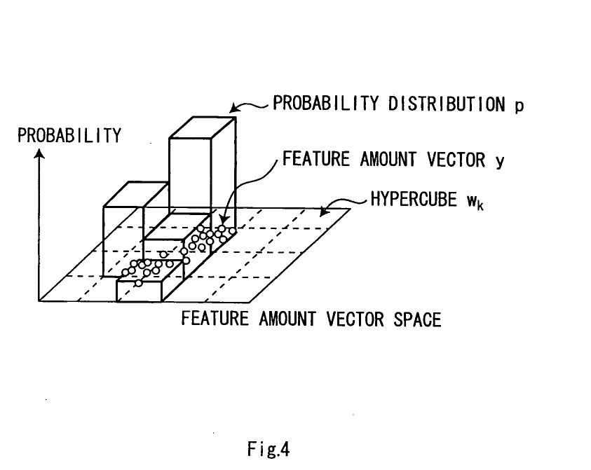

The probability distribution calculating unit 103 calculates a probability distribution for the feature amount vectors y belonging to the identical class cⱼ by applying, for example, a method called “Parzen window” to the feature amount vector space Y. Details of the “Parzen window” are described in Richard O. Duda, Peter E. Hart, and David G. Stork, “Pattern Classification (Second Edition)”, Wiley Interscience, 2000, which is hereby incorporated by reference. In this specification, an outline of the “Parzen window” will be explained with reference to FIG. 4.

The probability distribution calculating unit 103 divides the feature amount vector space Y into WL-dimensional hypercubes wₖ (k=1, 2, . . . ,W). In this embodiment, a volume vₖ of the L-dimensional hypercubes wₖ is in inverse proportion to the number “a” of the feature amount vectors y in the L-dimensional hypercubes wₖ. Note that the volume vₖ may be in inverse proportion to a positive square root or the like of “a”.

The number of feature amount vectors, which are included in the hypercubes wₖ and belong to the class cⱼ, is represented as numₖ (cⱼ). The probability distribution calculating unit 103 calculates a probability distribution p(y|cⱼ) on the basis of the following formula.

$$p ( y ∈ {w}_{k} \vert {c}_{j} ) = \frac{{num}_{k} ( {c}_{j} )}{{\sum }_{j = 1}^{W} {num}_{k} ( {c}_{j} )} \qquad [ Formula 1 ]$$

(Act S205) Storage of a Probability Distribution

The probability distribution storing unit 104 stores a probability distribution p(y∈wₖ|cⱼ) in association with the class cⱼ and the hypercubes wₖ.

A detailed flow of the learning processing is as described above.

The recognition processing will be explained with reference to FIG. 3.

(Act S301) Feature Amount Extraction Processing

The feature amount extracting unit 101 extracts the source feature amount vectors x from an inputted image of a recognition object in the same manner as act S201. The pattern recognition apparatus in this embodiment treats a luminance value itself of each pixel as a feature amount. Therefore, the feature amount extracting unit 101 extracts the m×n-dimensional source feature amount vectors x from the image of the recognition object.

(Act S302) Principal Component Analysis Processing

The feature amount extracting unit 101 calculates the L-dimensional feature amount vectors y from the source feature amount vectors x calculated for the recognition object. The feature amount extracting unit 101 calculates the L-dimensional feature amount vectors y according to a relational expression y=φ(x-xₐᵥₑ) using the average source feature amount vector xₐᵥₑ and the eigenvectors φᵢ read out from the parameter storing unit 113.

The feature amount extracting unit 101 outputs the plurality of L-dimensional feature amount vectors y to the posterior probability calculating unit 105.

(Act S303) Calculation of a Posterior Probability

The posterior probability calculating unit 105 searches for a hypercube to which each of the feature amount vectors y belongs out of the hypercubes wₖ. In the following explanation, the hypercube to which each of the feature amount vectors y belongs is represented as hypercube wₖ. The posterior probability calculating unit 105 calculates a posterior probability p(cⱼ|y∈wₖ) for the class cⱼ to which each of the feature amount vectors y belongs in the hypercube wₖ to which the feature amount vectors y belongs. The posterior probability p(cⱼ|y∈wₖ) is represented by the following formula on the basis of the Bayes' theorem.

$$p ( {c}_{j} \vert y ∈ {w}_{K} ) = \frac{p ( y ∈ {w}_{K} \vert {c}_{j} ) p ( {c}_{j} )}{p ( y )} \qquad [ Formula 2 ]$$

Since p(y) is common to all the classes cⱼ, p(y) may be neglected. Thus, the posterior probability calculating unit 105 calculates the posterior probability p(cⱼ|y∈wₖ) using the following formula.
p(cⱼ|y∈wₖ)∝p(y∈wₖ|cⱼ)p(cⱼ) [Formula 3]

Note that p(cⱼ) corresponds to an appearance probability (a prior probability) of the class cⱼ. In other words, p(cⱼ) corresponds to a probability that each learning object learned appears at the time of recognition. Therefore, if an assumption that all learning objects appear at an equal probability is a satisfactory analogue, the prior probability p(cⱼ) may be regarded as a constant term. The assumption is established, for example, when learning objects appear at random. When a specific learning object tends to appear, it is possible to determine a value of the prior probability p(cⱼ) by learning an appearance frequency.

The probability distribution p(y∈wₖ|cⱼ) is stored in the probability distribution storing unit 104 when the learning processing is performed. Thus, the posterior probability calculating unit 105 can calculate a posterior probability p(cⱼ|y) that the feature amount vectors y calculated from a certain recognition object belongs to a certain class cⱼ.

(Act S304) Recognition

The posterior probability comparing unit 106 searches for a largest posterior probability p(c_{J}|y) out of posterior probabilities calculated. The posterior probability comparing unit 106 calculates a class c_{J} corresponding to the largest posterior probability p(c_{J}|y). The posterior probability comparing unit 106 judges that the recognition object belongs to the class c_{J}.

Note that the posterior probability comparing unit 106 may be constituted such that, when the largest posterior probability p(c_{J}|y) does not exceed a threshold value, it is judged that a recognition object is not any one of learning objects.

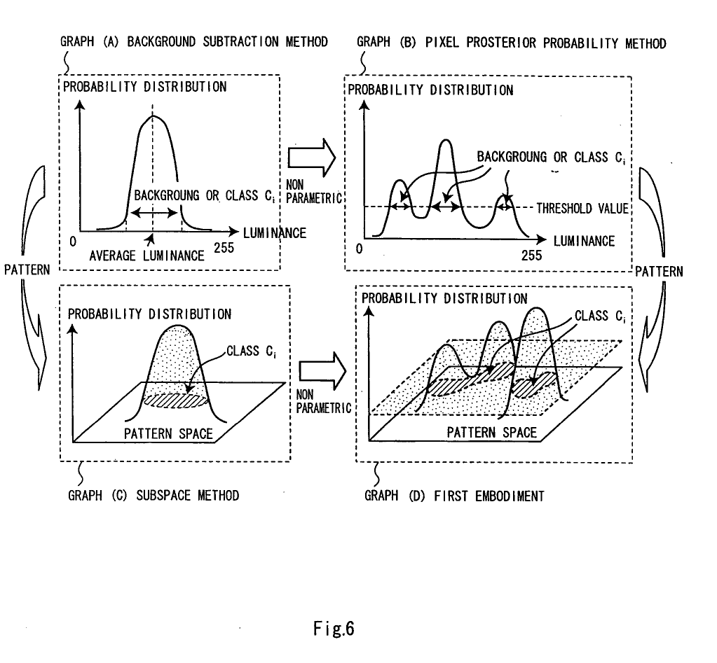

A detailed flow of the recognition processing is as described above. The pattern recognition apparatus in the first embodiment uses the pattern recognition method explained above. Thus, for example, it is possible to realize recognition of an object for an image without sufficient positioning and recognition and detection of a pattern in which positional deviation itself is a feature. In other words, since it is possible to perform the recognition processing without performing positioning, the pattern recognition apparatus is independent of and tolerates positional deviation in that positional deviation does not contribute to recognition of an object. Therefore, the apparatus and methods operate reliably in the presence or absence of positional deviation Differences between the first embodiment and reference examples will be hereinafter explained with reference to FIG. 6.

A first reference example is a background subtraction method. As shown in graph (A) of FIG. 6, the background subtraction method is a method of assuming that, if a certain pixel of attention is a background, a distribution of a luminance I thereof follows the Gaussian distribution. If a difference between the luminance I of the pixel of attention in an inputted image and an average luminance of the same pixel in a background image learned in advance is equal to or smaller than a predetermined threshold value, it is judged that the pixel is a background (normal). Otherwise, it is judged that the pixel is an intruder (abnormal).

A second reference example is a method based on a posterior probability of a pixel. Japanese Patents Nos. 3486229 and 3490196 are examples of the method, and both are hereby incorporated by reference. In the method, as shown in graph B of FIG. 6, a posterior probability p(background|I) of a pixel of attention in an inputted image is calculated in accordance with the Bayes' theorem from a probability distribution p(I|background) of a luminance I of a pixel of attention in a learning image concerning a background. Then, it is judged whether the pixel is a background according to comparison of the posterior probability p(background|I) and a threshold value.

A third reference example is a method based on a subspace. The method disclosed in M. Seki, et al., “A robust background subtraction method for changing background”, MIRU-2000, Vol. 2, pp. 403-408, July 2000 is an example of the method, and is hereby incorporated by reference. In the method, as shown in graph C of FIG. 6, it is assumed that a distribution of a pattern follows a model such as the Gaussian distribution. If a pattern of an area of attention in an inputted image is sufficiently close to a pattern distribution of a class cᵢ, it is judged that the area in the class cᵢ (e.g., a background). Otherwise, it is judged that the area is in another class (e.g., an intruder).

On the other hand, the method in the first embodiment is a method obtained by expanding the method in the second reference example to a pattern space (or a method obtained by expanding the subspace method in the third reference example to a nonparametric method of not assuming a model) (corresponding to graph D of FIG. 6). Since a distribution of a pattern is used instead of aluminance of a pixel, which is local information, positional deviation is allowed in the method in the first embodiment. A distribution of a pattern with positional deviation does not match a model such as the Gaussian distribution. Therefore, a model is not assumed in the method in the first embodiment. In the method in the first embodiment, a posterior probability p(cᵢ|y) of a pattern of attention in an image of a recognition object is calculated using a probability distribution p(y|cᵢ) of feature amount vectors (pattern of attentions) y in an image of a learning object and Formula 2. Then, it is judged that whether the recognition object belongs to a class cᵢ on the basis of a magnitude of a posterior probability p(cᵢ|y).

A modification of the first embodiment will be hereinafter explained.

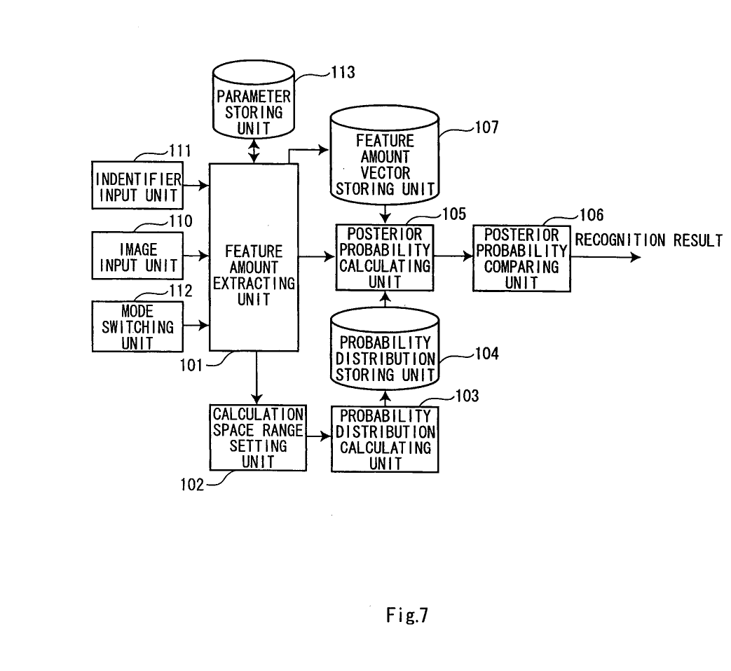

When a posterior probability is calculated in the first embodiment, it is possible to use the k-Nearest Neighbor instead of the Parzen window. FIG. 7 is a block diagram of a pattern recognition apparatus in the modification at the time when the k-Nearest Neighbor is used.

The pattern recognition apparatus in the modification is different from the pattern recognition apparatus in the first embodiment in that the pattern recognition apparatus in the modification has a learning feature amount vector storing unit 107. The difference will be mainly explained below.

The learning feature amount vector storing unit 107 stores D L-dimensional feature amount vectors among L-dimensional feature amount vectors that are calculated by the feature amount extracting unit 101 at the time of the learning processing. When the posterior probability calculating unit 105 calculates a posterior probability, the posterior probability calculating unit 105 selects high order k learning feature amount vectors close in distance to feature amount vectors y calculated from an image of a recognition object out of the D learning feature amount vectors. When there are kⱼ learning feature amount vectors belonging to a class cⱼ among the k learning feature amount vectors, the posterior probability calculating unit 105 calculates a posterior probability using the following formula.

$$p ( {c}_{j} \vert y ) = \frac{{k}_{i}}{k} \qquad [ Formula 4 ]$$

Alternatively, the posterior probability calculating unit 105 may extract high order k learning feature amount vectors, which belong to the class cⱼ and are close in distance to the feature amount vectors y, out of the D learning feature amount vectors and calculate a posterior probability using the following formula on the basis of distances dist (y, cⱼ, m) (m=1, . . . , k) with respect to the feature amount vectors y.

$$p ( {c}_{j} \vert y ) = \frac{1}{\frac{1}{k} {\sum }_{j = 1}^{k} dist ( y , {c}_{j} , m )} \qquad [ Formula 5 ]$$

Note that the posterior probability calculating unit 105 may output a posterior probability obtained by subjecting the posterior probability calculated by using Formula 4 or Formula 5 and the posterior probability calculated by using Formula 2 to simple averaging or weighted averaging as a final posterior probability. Consequently, a result of calculation of a posterior probability is considered to be stabilized.

The feature amount extracting unit 101 in the first embodiment extracts the m×n-dimensional source feature amount vectors x with a luminance value of each pixel of an image having m pixels vertically and n pixels horizontally as a feature amount. The feature amount extracting unit 101 in the modification divides an image having m pixels vertically and n pixels horizontally into a plurality of blocks of a predetermined size (e.g., 8 pixels×8 pixels). Then, for example, the feature amount extracting unit 101 extracts a 64-dimensional source feature amount vector xₛ (s=1, . . . , number of divisions) with a luminance value of each pixel in each of the blocks as a feature amount.

The feature amount extracting unit 101 in the modification applies the principal component analysis to the source feature amount vector xₛ extracted by a unit of block. For example, when a plurality of images are inputted, the feature amount extracting unit 101 applies the principal component analysis to a plurality of source feature amount vectors xₛ extracted from blocks in the same positions in the images. Then, the feature amount extracting unit 101 calculates a probability distribution by a unit of block.

Similarly, concerning the recognition processing, the feature amount extracting unit 101 calculates the feature amount vector y from the recognition object by a unit of block and calculates a posterior probability by a unit of block. It is possible to calculate an overall posterior probability according to, for example, a product of posterior probabilities of respective blocks. Alternatively, it is also possible to perform the recognition processing according to the number, a ratio, a degree of integration, a density of blocks having posterior probabilities equal to or higher than a predetermined threshold value. If the pattern recognition apparatus is applied to a system for monitoring an abnormal state and a normal state, it is also possible to judge normality and abnormality by a unit of block.

### Second Embodiment

A second embodiment of the invention will be hereinafter explained with reference to the accompanying drawings.

The pattern recognition apparatus in the first embodiment performs recognition by comparing a posterior probability of the class cⱼ and posterior probabilities of other classes c_{g}. However, it is not always possible to calculate feature amount vectors of all classes.

In the case of a monitoring system that recognizes and distinguishes a normal state and an abnormal state, it is easy to obtain a feature amount vector of a normal state class c₀ corresponding to the normal state. However, it is not rare that it is difficult to obtain a feature amount vector of an abnormal state class c_{I} corresponding to the abnormal state. For example, it is not realistic to set fire to a building being monitored in order to cause a system for monitoring a building to learn a fire state.

In the case of such a system, processing for judging that a state is abnormal when divergence from the normal state exceeds a threshold value is often performed. However, appropriateness of threshold value setting can be a problem. Thus, the pattern recognition apparatus in this embodiment performs recognition by estimating a probability distribution for calculating a posterior probability for a class for which it is difficult to obtain a feature amount vector.

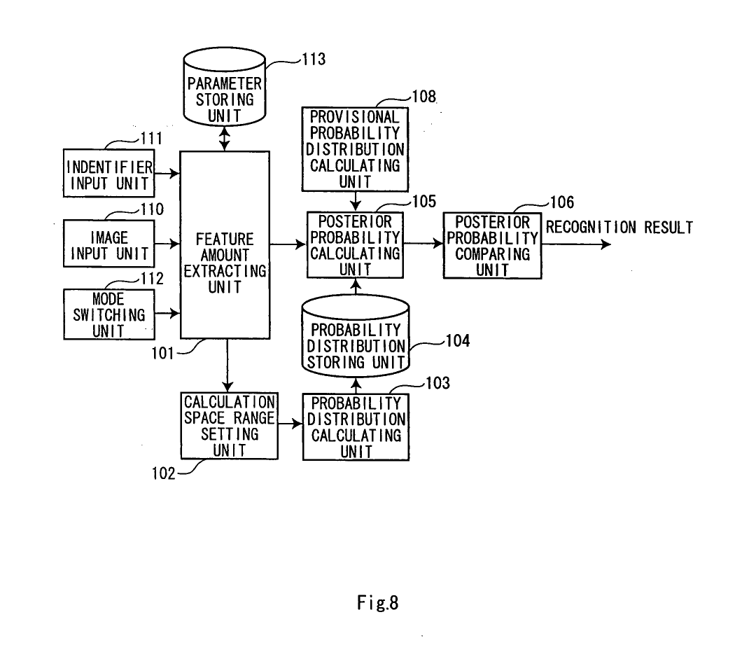

FIG. 8 is a block diagram of the pattern recognition apparatus in this embodiment. The pattern recognition apparatus in this embodiment is different from the pattern recognition apparatus in the first embodiment in that the pattern recognition apparatus in this embodiment includes a provisional probability distribution calculating unit 108. The difference from the first embodiment will be explained in greater detail.

The provisional probability distribution calculating unit 108 calculates a provisional probability distribution for calculating a posterior probability for a class for which it is difficult to obtain a feature amount vector. The provisional probability distribution calculating unit 108 calculates a provisional probability distribution using probability distributions of other classes that have been learned. In this embodiment, a uniform distribution is used as the provisional probability distribution.

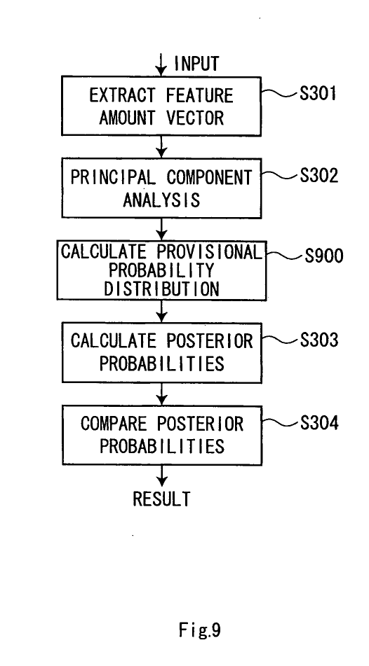

FIG. 9 is a flowchart of recognition processing of the pattern recognition apparatus in this embodiment. The recognition processing is basically the same as that in the first embodiment described in FIG. 3. However, the recognition processing is different from that in the first embodiment in that the recognition processing includes an act of calculating a provisional probability distribution (act S900) and a posterior probability is calculated using the provisional probability distribution as well in the act of calculating a posterior probability (act S303). The differences from the first embodiment will be explained in greater detail. (Act S900) Calculation of a provisional probability distribution

The provisional probability distribution calculating unit 108 calculates a probability distribution in which probabilities are distributed uniformly in a certain range. Therefore, the provisional probability distribution calculating unit 108 calculates a distribution range.

The provisional probability distribution calculating unit 108 reads out the average source feature amount vector xₐᵥₑ and the eigenvectors φᵢ from the parameter storing unit 113 and calculates the average feature amount vector yₐᵥₑ using a formula yₐᵥₑ=[φ₁, φ₂, . . . , φ_{L}] (Xₐᵥₑ). The average feature amount vector yₐᵥₑ defines a center of a provisional probability distribution.

The provisional probability distribution calculating unit 108 reads out all eigenvalues λᵢ from the parameter storing unit 113. A basis vector of an ith dimension in a feature amount vector space is parallel to any one of the eigenvectors φᵢ. In other words, the basis vector of the i-th dimension is a vector obtained by multiplying the eigenvector φᵢ by a scalar. The provisional probability distribution calculating unit 108 defines a distribution range of a provisional probability distribution of the ith dimension using the eigenvalue λᵢ corresponding to the eigenvector φᵢ.

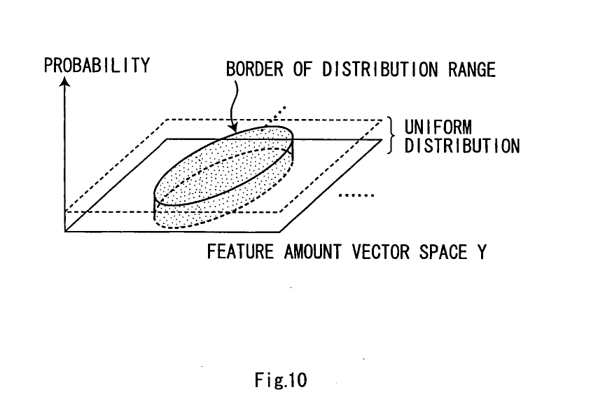

The provisional probability distribution calculating unit 108 calculates a uniform probability distribution in a space with a radius rλᵢ with the average feature amount vector yₐᵥₑ as a center. For example, when the space with a radius rλᵢ includes v hypercubes wₖ each shown in FIG. 4, the space with a radius rλᵢ has the uniform probability distribution of probability 1/v. The uniform probability distribution calculated is a provisional probability distribution (FIG. 10).

(Act S303) Calculation of a Posterior Probability

A posterior probability is calculated in the same manner as the first embodiment. However, the posterior probability calculating unit 105 in this embodiment calculates both a posterior probability for a provisional probability distribution and a posterior probability for a probability distribution stored in the probability distribution storing unit 104. In other words, the posterior probability calculating unit 105 calculates, by using the uniform probability, a posterior probability of a class difficult to learn enough amount in order to obtain a feature amount vector. For example, the posterior probability calculating unit 105 uses the uniform probability for a class having a smaller amount of leaning data than a threshold.

As explained above, with the pattern recognition apparatus in this embodiment, it is possible to recognize a pattern even when there is a class that is hard to learn.

### Third Embodiment

A third embodiment of the invention will be hereinafter explained with reference to the accompanying drawings.

The recognition methods based on a posterior probability explained in the first and the second embodiments is the nonparametric method of not assuming a distribution model of a pattern. In these methods, as the amount of learning data increases, the performance increases and generally the method requires a relatively large number of learning data in order to obtain high performance.

On the other hand, in the parametric method represented by the subspace method, rather high performance is often obtained even if an amount of learning data is relatively small.

Thus, in the pattern recognition apparatus in this embodiment, improvement and stabilization of recognition performance are realized by combining other methods (e.g., the parametric method) with the pattern recognition apparatuses in the first and the second embodiments.

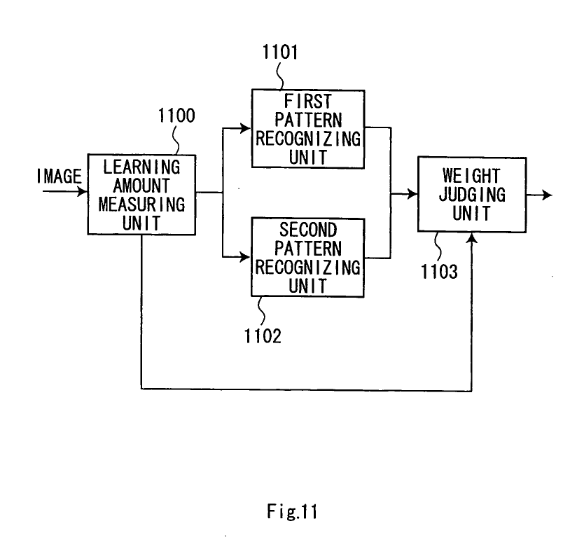

FIG. 11 is a block diagram of the pattern recognition apparatus in this embodiment. The pattern recognition apparatus in this embodiment includes a learning amount measuring unit 1100 that monitors an amount of data inputted at the time of learning processing and measures an amount of learning, a first pattern recognizing unit 1101 equivalent to the pattern recognition apparatus in the first or the second embodiment, a second pattern recognizing unit 1102 that performs pattern recognition by other methods, and a weight judging unit 1103 that weights results of recognition by the first pattern recognizing unit 1101 and the second pattern recognizing unit 1102 and outputs a final recognition result.

The first pattern recognizing unit 1101 and the second pattern recognizing unit 1102 receive an input of an image of a recognition object, perform recognition according to the respective recognition methods, and output a first recognition result and a second recognition result to the weight judging unit 1103.

The second pattern recognizing unit 1102 performs recognition according to methods (other methods) with which accurate and reliable recognition performance is obtained compared with the recognition methods in the first and the second embodiments even when an amount of leaning data is small. For example, it is possible to use a recognition method according to a subspace method (e.g., Oja Erkki, “Subspace methods of pattern recognition”) and a recognition method that uses a multiple discriminant analysis method (Richard O. Duda, Peter E. Hart, and David G. Stork, “Pattern Classification (Second Edition)”, Wiley Interscience, 2000, which is hereby incorporated by reference).

The learning amount measuring unit 1100 supplies an inputted image to the first pattern recognizing unit 1101 and the second pattern recognizing unit 1102. The learning amount measuring unit 1100 monitors the number of images or the number of learning objects inputted while the first pattern recognizing unit 1101 and the second pattern recognizing unit 1102 execute the learning processing. The learning amount measuring unit 1100 holds the number of images or the number of learning objects as a learning amount. When recognition processing is performed, the first pattern recognizing unit 1101 and the second pattern recognizing unit 1102 output the learning amount to the weight judging unit 1103.

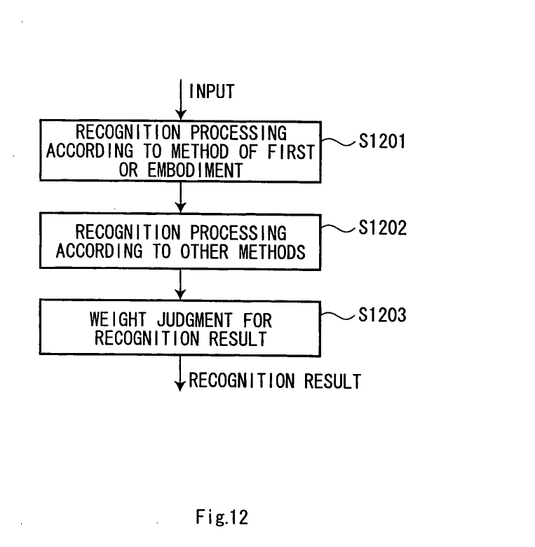

FIG. 12 is a flowchart of recognition processing by the pattern recognition apparatus in this embodiment.

(Act S1201) The first pattern recognizing unit 1101 performs recognition according to the recognition method explained in the first or the second embodiment. The first pattern recognizing unit 1101 outputs a first recognition result and a first learning amount to the weight judging unit 1103.

(Act S1202) The second pattern recognizing unit 1102 performs recognition according to other methods (a method different from the method used by the first pattern recognizing unit 1101 in act S1201). The second pattern recognizing unit 1102 outputs a second recognition result and a second learning amount to the weight judging unit 1103. Note that, in this embodiment, it is assumed that the first recognition result and the second recognition result have degrees of similarity of the same scale.

(Act S1203) The weight judging unit 1103 calculates a weighting coefficient on the basis of the learning amount and weights the first recognition result and the second recognition result on the basis of the coefficient to calculate a final recognition result.

In this embodiment, weighting is performed such that, when the learning amount is small, increased importance is attached to the second recognition result and, as the learning amount increases, increased importance is attached to the first recognition result. For example, when a weighting coefficient for the first recognition result is α (a weighting coefficient for the second recognition result is 1−α), a learning amount is n, and a design coefficient is β (β>0), the weighting coefficient is calculated on the basis of the following formula.

$$α = \frac{{n}^{β} - 1}{{n}^{β}} \qquad [ Formula 6 ]$$

According to Formula 6, as the learning amount n increases, the weighting coefficient α for the first recognition result increases (gradually approaches 1 from 0).

The weight judging unit 1103 calculates a final recognition result using a result of adding up or combining the two recognition results on the basis of the weighting coefficient. For example, it is possible to judge whether a recognition object matches any one of learned objects or does not match any of the learned objects by comparing the final recognition result with a threshold value.

Note that when the second pattern recognizing unit 1102 performs recognition according to a plurality of methods and there are a plurality of (e.g., m) second recognition results, a weighting coefficient of each of the second recognition results is (1α)/m.

With the pattern recognition apparatus explained above, even when a learning amount is small, it is possible to realize stable high recognition performance as in the case in which a learning amount is large.

Although the invention is shown and described with respect to certain illustrated aspects, it will be appreciated that equivalent alterations and modifications will occur to others skilled in the art upon the reading and understanding of this specification and the annexed drawings. In particular regard to the various functions performed by the above described components, the terms used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

What is claimed is:

1. A pattern recognition apparatus comprising:
an image input unit that inputs a plurality of images concerning each of a learning object and a recognition object;
a feature amount vector calculator that calculates a feature amount vector of each of the images;
a range setting unit that sets a calculation range in a feature amount vector space;
a probability distribution calculator that calculates, concerning the learning object, a probability distribution of the feature amount vectors in the calculation range;
a probability distribution storage that stores the probability distribution in association with the learning object;
a posterior probability calculator that calculates a posterior probability that the recognition object is the learning object using feature amount vectors concerning the recognition object and the probability distribution; and
a recognizing unit that recognizes the recognition object on the basis of the posterior probability.

2. A pattern recognition apparatus according to claim 1,
wherein the feature amount vector calculator comprises:
a source feature amount vector calculator that calculates, concerning each of the images, source feature amount vectors having a plurality of feature amounts as components; and
a principal component analysis calculator that applies principal component analysis to the source feature amount vectors concerning each of the learning object and the recognition object and calculates the feature amount vectors of L dimensions and L eigenvalues for each of the source feature amount vectors,
wherein the range setting unit sets a range of a distance, which is defined according to magnitudes of the eigenvalues with an average of the feature amount vectors as a center, as the calculation range.

3. A pattern recognition apparatus according to claim 1, wherein the posterior probability calculator calculates a posterior probability according to a k-Nearest Neighbor.

4. A pattern recognition apparatus according to claim 1,
wherein the probability distribution calculator comprises:
a comparator that compares a number of the input images concerning the learning object and a threshold value; and
a provisional probability distribution calculator that calculates, when the number of the input images concerning the learning object is smaller than the threshold value, a provisional probability distribution in the calculation range as a probability distribution of the feature amount vectors concerning the learning object.

5. A pattern recognition apparatus according to claim 4, wherein the provisional probability distribution calculator calculates a uniform probability distribution in the calculation range.

6. A pattern recognition apparatus according to claim 1, further comprising:
a pattern recognizing unit that recognizes the recognition object using an image of the recognition object and a learning result obtained in advance; and
a recognition result generator that generates a general recognition result using a result of recognition by the pattern recognizing unit and a result of recognition by the recognizing unit.

7. A pattern recognition apparatus according to claim 6,
wherein the probability distribution storage stores a number of learning data corresponding to a number of images of the learning object that have been inputted or a number of the feature amount vectors of the learning object that have been calculated, and
wherein the recognition result generating unit increases contribution of the result of recognition by the recognizing unit to the general recognition result as the number of leaning data increases.

8. A pattern recognition apparatus according to claim 6, wherein the pattern recognizing unit performs recognition according to a parametric recognition method.

9. A pattern recognition method comprising:
inputting a plurality of images concerning each of a learning object and a recognition object;
calculating a feature amount vector of each of the images;
setting a calculation range in a feature amount vector space;
calculating, concerning the learning object, a probability distribution of the feature amount vectors in the calculation range;
storing the probability distribution in association with the learning object;
calculating a posterior probability that the recognition object is the learning object using feature amount vectors concerning the recognition object and the probability distribution; and
recognizing the recognition object on the basis of the posterior probability.

10. A pattern recognition method according to claim 9,
wherein calculating the feature amount vector comprises:
calculating, concerning each of the images, source feature amount vectors having a plurality of feature amounts as components; and
applying principal component analysis to the source feature amount vectors concerning each of the learning object and the recognition object and calculating the feature amount vectors of L dimensions and L eigenvalues for each of the source feature amount vectors,
wherein setting the calculation range sets a range of a distance, which is defined according to magnitudes of the eigenvalues with an average of the feature amount vectors as a center, as the calculation range.

11. A pattern recognition method according to claim 9, wherein calculating the posterior probability calculates a posterior probability according to a k-Nearest Neighbor.

12. A pattern recognition method according to claim 9,
wherein calculating the probability distribution comprises:
comparing a number of the input images concerning the learning object and a threshold value; and
calculating, when the number of the input images concerning the learning object is smaller than the threshold value, a provisional probability distribution in the calculation range as a probability distribution of the feature amount vectors concerning the learning object.

13. A pattern recognition method according to claim 12, wherein calculating the provisional probability distribution calculates a uniform probability distribution in the calculation range.

14. A pattern recognition apparatus comprising:
an image input unit that inputs a plurality of images concerning a recognition object;
a feature amount vector calculator that calculates a feature amount vector of each of the images;
a probability distribution storage that stores a probability distribution in a feature amount vector space of feature amount vectors calculated in advance concerning a learning object;
a posterior probability calculator that calculates a posterior probability that the recognition object is the learning object using feature amount vectors concerning the recognition object and the probability distribution of the learning object stored in the probability distribution storage; and
a recognizing unit that recognizes the recognition object on the basis of the posterior probability.

15. An apparatus for generating a dictionary for pattern recognition comprising:
an image input unit that inputs a plurality of images concerning a learning object;
a feature amount vector calculator that calculates a feature amount vector of each of the images;
a range setting unit that sets a calculation range in a feature amount vector space;
a probability distribution calculator that calculates, concerning the learning object, the probability distribution of the feature amount vectors in the calculation range; and
an output unit that outputs data in which the probability distribution is associated with the learning object.

16. An apparatus according to claim 15,
wherein the feature amount vector calculator comprises:
a source feature amount vector calculator that calculates, concerning each of the images, source feature amount vectors having a plurality of feature amounts as components; and
a principal component analysis calculator that applies principal component analysis to the source feature amount vectors concerning each of the learning objects and calculates the feature amount vectors of L dimensions and L eigenvalues for each of the source feature amount vectors,
wherein the range setting unit sets a range of a distance, which is defined according to magnitudes of the eigenvalues with an average of the feature amount vectors as a center, as the calculation range.

17. An apparatus according to claim 15, wherein the posterior probability calculator calculates a posterior probability according to a k-Nearest Neighbor.

18. An apparatus according to claim 15,
wherein the probability distribution calculator comprises:
a comparator that compares a number of the input images concerning the learning object and a threshold value; and
a provisional probability distribution calculator that calculates, when the number of the input images concerning the learning object is smaller than the threshold value, a provisional probability distribution in the calculation range as a probability distribution of the feature amount vectors concerning the learning object.
